(19) United States
(12) Patent Application Publication
(10) Pub. No.: US 2014/0113042 A1
(43) Pub. Date: Apr. 24, 2014

(54) METHOD AND APPARATUS FOR MANUFACTURING EDIBLE FILM PRODUCT

(71) Applicants: KWANG DONG PHARMACEUTICAL CO., LTD, Seoul (KR); C.L. PHARM CORPORATION, Seoul (KR)

(72) Inventors: Gang Mo Sung, Cheonan-si (KR); Won Jin Kim, Asan-si (KR); Seok Hoon Chang, Mapo-gu (KR); Jeong Jun Yu, Gunpo-si (KR)

(21) Appl. No.: 14/122,781

(22) PCT Filed: Dec. 10, 2012
(86) PCT No.: PCT/KR2012/010688

§ 371 Date: Jan. 7, 2014

(30) Foreign Application Priority Data
Dec. 12, 2011 (KR) 10-2011-0133225

(51) Int. Cl. A23P 1/08

(52) U.S. Cl. CPC A23P 1/086
USPC 426/303; 118/20

(57) ABSTRACT

A method and apparatus for manufacturing an edible film are disclosed. The method includes a plurality of applying operations of applying solution for forming the edible film onto lower wrapping paper in a thin film shape. The solution-applying operations include a first solution-applying and a second solution-applying operation. Therefore, in the case of an edible medicine film product, particularly, when a tiny dosage of medicine must be loaded onto an edible medicine film, a loss of medicine can be reduced as much as possible. A variety of kinds of films can be manufactured through a multi-solution-applying operation, when different kinds of medicines, for example, those which are respectively absorbed in the mouth mucous membrane, the stomach and the intestine, are required.

### TECHNICAL FIELD

The present invention relates to a method and apparatus for manufacturing an edible film product in which a film can be formed through a multiple-solution-applying operation so that as necessary, a variety of kinds of films can be manufactured.

### BACKGROUND ART

Generally, edible films are substances which are formed in a film shape by mixing material that is harmless to humans with raw material such as starch that is harmless to humans and dissolves easily in water. The edible films are used to administer beneficial material to human bodies through the mouth or skin. For example, if a user places an edible film in his/her mouth causing it to dissolve with saliva, material beneficial to the human body can be easily administered. Furthermore, some edible films may be attached to the skin or the like to apply cosmetics or administer chemicals to the human body.

Currently, edible mouthwash film is produced in such a way that substances for the prevention of halitosis, fragrances such as peppermint or menthol, and food colorings are all added to an edible film. Such an edible mouthwash film has been widely used as a substitute for gums or candies which may have a negative impact on the environment, and lead to the deterioration of a person's dental health. Particularly, edible mouthwash films may be offered as an alternative after-dinner treat in large restaurants which typically provide sugary foods such as mints of candies to customers.

Edible films are thin and are vulnerable to water. Typically, an edible film is cut to form a plurality of pieces of an appropriate size. Each piece of edible film may be packed and sealed in wrapping paper. Alternatively, the pieces having predetermined sizes may be stored in a dispenser so that the users can pull the pieces out one by one from the dispenser. As a further alternative, an edible film roll may be stored in a dispenser. In this case, the edible film can be used in such a way that the dispenser cuts a predetermined length of edible film and dispenses it.

In the case where pieces of edible film are individually packed, an edible film manufacturing line and a packing line are typically separately provided in the conventional art.

FIG. 1 is of schematic views showing a conventional apparatus for manufacturing and packing an edible film.

The conventional apparatus for manufacturing an edible film includes a producing unit 10 which produces an edible film roll, a separation unit 20 which divides the edible film into a plurality of pieces, and a packing unit 30 which packs and seals the edible film pieces using wrapping paper. The producing unit 10, the separation unit 20 and the packing unit 30 are separately provided.

In the producing unit 10, liquefied material (hereinafter referred to as solution) for the edible film is supplied to a solution supply unit 11. The producing unit 10 includes a coater 12. The coater 12 applies solution, supplied from the solution supply unit 11, onto an upper surface of a coating conveyer 13 so that an edible film of a constant thickness is formed on the coating conveyer 13. The edible film 1 that has been formed by the coater 12 is dried by a drier 14.

The edible film 1 that has been dried by the drier 14 is separated from the coating conveyer 13 and formed into a roll shape by a winding unit 15. Here, the edible film can be formed in such a way that a base film is supplied onto the upper surface of the coating conveyer 13 and solution is onto an upper surface of the base film. The reason for this is that portions of the edible film can be prevented from adhering to each other when it is wound in a roll shape, and the winding operation and transportation thereof can be facilitated. Depending on the kind of edible film, the base film may not be used. Given this, the detailed illustration of the base film is omitted in FIG. 1. In the conventional edible film manufacturing apparatus having the above-mentioned construction, the coater 12 is disposed above the coating conveyor 13. A knife coater, a comma coater or a slot coater may be used as the coater 12. The coater 12 can use flexo printing, aniline printing, two-color injection, laser printing, silk-screen printing, etc. The coater 12 continuously discharges solution at a constant supply rate so that the edible film 1 having a constant thickness can be formed on the upper surface of the coating conveyer 13 that is rotating.

After the edible film 1 has been formed, it passes through the drier 14 so that it is dried.

The edible film 1 has been formed, it passes through the drier 14 so that it is dried.

The edible film that has passed through the drier 14 is separated from the coating conveyer 13 by the winding unit 15 and wound around a roller. Then, an edible film roll having a predetermined width is produced.

The separation unit 20 functions to divide the film, which has been manufactured to have a comparatively long and wide shape, into a plurality of pieces. While the edible film 1 that has been wound around the roller is transferred onto transfer conveyer, a slitter 21 divides the edible film 1 into several film rows, each of which has a width corresponding to that of an edible film piece. Thereafter, the edible film rows that have been transferred are cut at a predetermined length by a cutter 22. Thereby, pluralities of edible film pieces are formed. The edible film pieces are placed into a transfer container 23.

The packing unit 30 provides a lower wrapping paper 31. The edible film pieces 1 (hereinafter, also referred to as the edible films) that are contained in the transfer container 23 are arranged on an upper surface of the lower wrapping paper 31. Subsequently, an upper wrapping paper 32 is supplied onto the arranged edible films 1. Thereafter, a heat sealer 33 thermo-compresses portions of the upper and lower wrapping paper 32 and 31 around each edible film 1, this sealing the edible films 1. After the sealing operation has been completed by the heat sealer 33, a slitter 34 which divides the wrapping paper 31 and 32 into several portions with respect to the longitudinal direction and a cutter 35 which is used to cut them in the lateral direction are used to form individually packed edible films. Alternatively, the slitter 34 and the cutter 35 may form perforated lines so that the individually packed edible films can be easily separated from each other.

As such, because the edible film is divided into a plurality of pieces before they are packed, the number of manufacturing operations is increased, and a roll-shaped semi-product stock is piled. Thereby, the productivity is reduced, and the stock burden is causative of the production cost. In addition, the rolled film must be kept free from contaminants while it is being stored, thus requiring an additional management system.

Moreover, because application of the solution is conducted by a single process, when a very small amount of medicine is loaded onto a film, a loss of medicine may easily occur. Further, there is a disadvantage in that a variety of kinds of film products, which may be required as necessary depending on the kind of medicines that are absorbed in different portions of the human body, cannot be manufactured.

### DISCLOSURE

### Technical Problem

Accordingly, the present invention has been made keeping in mind the above problems occurring in the prior art, and an object of the present invention is to provide a method and apparatus for manufacturing an edible film product in which a multi-solution applying operation depending on the kind of medicines that are absorbed by different parts, for example, the mouth mucous membrane, the stomach, the intestine, etc., of the human body.

### Technical Solution

In order to accomplish the above object, in an aspect, the present invention provides a method of manufacturing an edible film, including; a plurality of applying operations of applying a solution for forming the edible film onto lower wrapping paper in a thin film shape, the solution applying operations comprising a first solution-applying operation and a second solution-applying operation.

The method may further include, between the first solution applying operation and the second solution applying operation, a semi-drying operation of semi-drying an edible film formed on the lower wrapping paper by the first solution applying operation.

Either the first solution-applying operation or the second solution-applying operation may include applying a water soluble composition solution, and a remaining one of the first solution-applying operation and the second solution-applying operation may include applying a fat-soluble composition solution.

The method may further include: after the solution applying operations, a drying operation of drying the edible film formed on the lower wrapping paper; an upper wrapping paper supply operation of supplying upper wrapping paper onto the lower wrapping paper on which the edible film has been formed and dried; a sealing operation of thermo-compressing a perimeter of the upper wrapping paper and a perimeter of the lower wrapping paper to each other and sealing the perimeters; a slitting operation dividing the sealed upper and lower wrapping paper into a plurality of portions with respect to a longitudinal direction; and a cutting operation of cutting in a lateral direction of the upper and lower wrapping paper of the edible film that has passed through the slitting operation.

The solution-applying operations may include applying the solution onto the upper surface of the lower wrapping paper in such a way that a plurality of edible films having a predetermined size are arranged in rows parallel to each other during a single applying process.

The solution-applying operations may include spraying the solution perpendicular onto an upper surface of the lower wrapping paper from a nozzle, wherein while the solution is sprayed, the nozzle is tilted in a direction in which the lower wrapping paper is transferred.

In another aspect, the present invention provides an apparatus for manufacturing an edible film, including: a water-soluble solution supply unit supplying a water-soluble solution for forming the edible film; a first coating conveyer comprising a support for application and transfer of the water soluble solution; a lower wrapping paper supply unit supplying a lower wrapping paper for packing the edible film onto an upper surface of the first coating conveyer; a multi-intermittent water soluble-composition-solution-applying unit applying the water-soluble solution supplied from the water-soluble solution supply unit onto an upper surface of the lower wrapping paper in such a way that a plurality of pieces of edible films are separately formed by repeatedly conducting application of the water soluble solution and interruption of the application;

The apparatus may further include a semi-drying unit disposed in rear of the first coating conveyer to semi-dry the water-soluble edible film formed by the multi-intermittent water soluble composition solution applying unit.

The multi-intermittent water-soluble composition-solution applying unit may include a nozzle spraying water soluble solution perpendicular to the lower wrapping paper supplied by a roller, the nozzle being provided so as to be rotatable.

The multi-intermittent water soluble composition solution applying unit may include a tilting unit tilting the nozzle whereby while the water soluble solution is sprayed, the nozzle is tilted in a direction corresponding to a direction in which the roller rotates.

### Advantageous Effects

A method and apparatus for manufacturing an edible film product according to the present invention have the following effects.

A solution applying operation includes the plurality of operations including the first solution applying operation and the second solution applying operation. Therefore, in the case of an edible medicine film product, particularly, when a tiny dosage of medicine must be loaded onto an edible medicine film, a loss of medicine can be reduced as much as possible.

Furthermore, in the present invention, a variety of kinds of films can be manufactured through a multi-solution applying operation, when different kinds of medicines, for example, those which are respectively absorbed in the mouth mucous membrane, the stomach and the intestine, are required.

Particularly, in the present invention, a water-soluble composition solution and a fat-soluble composition solution can be separately applied to a lower wrapping paper. Thus, in the case of medicine manufacture, it can be manufactured in such a way that water-soluble medicine is loaded onto a film before a small amount of fat-soluble medicine, which cannot resist heat, is applied to the film. As a result, chemical changes in the medicine attributable to heat can be minimized.

Furthermore, a semi-drying operation is conducted between the first solution-applying operation and the second solution-applying operation to set desired temperature and moisture levels and to appropriately mix raw materials. The semi-drying operation makes it possible to secure the stability of materials and makes the overall process more convenient.

In addition, the semi-drying operation is required when using a variety of techniques which are needed to apply raw materials to form a film, for example, an encapsulation technique for loading a fragrance onto a base film, or a micro-coating or nano-spray coating technique.

The edible film is directly formed on the upper surface of the lower wrapping paper in such a way that the water-soluble composition solution and fat-soluble composition solution are applied onto the lower wrapping paper through separate process. Thus, manufacture of the edible film product and the operation of packing can be conducted at the same time. Therefore, it is not required to separately transfer the edible film, so the edible film can be prevented from being contaminated with impurities.

Furthermore, a single product line can produce packed complete products, thus increasing the productivity, and reducing production equipment requirements and space required for the installation of the equipment, and reducing the number of processes. As a result, the production cost can be reduced, while the quality of the products can be enhanced.

Also, in the present invention, when a nozzle sprays the water-soluble composition solution perpendicular to the lower wrapping paper supplied by a roller, the nozzle is tilted in a direction corresponding to the direction in which the roller rotates. Thereby, the water-soluble composition solution which a comparatively high viscosity is prevented from stretching (forming a tail) so that water-soluble composition solution can be accurately sprayed on a target portion.

### DESCRIPTION OF DRAWINGS

FIG. 1 is of schematic views showing a conventional apparatus for forming and packing of an edible film;

FIG. 2 is a flowchart of a method of manufacturing an edible film product according to the present invention;

FIG. 3 is a schematic view of an apparatus for manufacturing an edible film product, according to a first embodiment of the present invention;

FIG. 4 is a schematic view of an apparatus for manufacturing an edible film product, according to a second embodiment of the present invention;

FIG. 5 is a view illustrating an embodiment of a multi-intermittent water-soluble-composition solution applying unit according to the present invention;

FIG. 6 is a view showing an example of a heat sealing method according to the present invention; and

FIGS. 7 and 8 are views illustrating an embodiment of a multi-intermittent water-soluble-composition-solution applying unit according to the present invention.

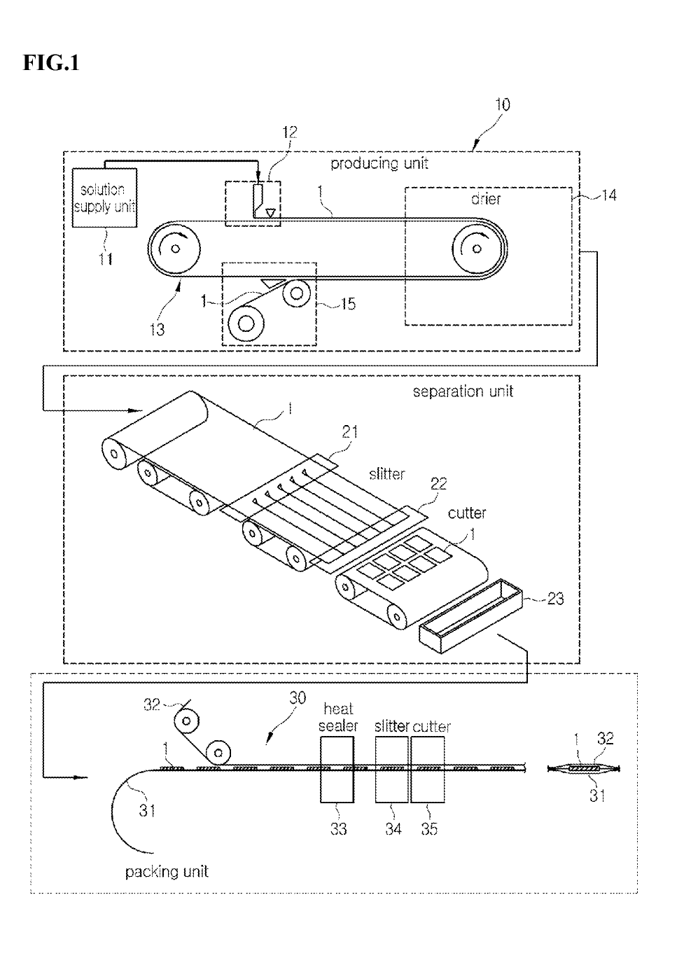

### BEST MODE

Hereinafter, preferred embodiments of the present invention will be described in detail with reference to the attached drawings. The terms and words used in the specification and claims must not be limited to typical or dictionary meanings, but must be regarded as concepts selected by the inventor as concepts which best illustrate the present invention, and must be interpreted as having meanings and concepts adapted to the scope and spirit of the present invention to aid in understanding the technology of the present invention.

Therefore, the construction of the embodiment illustrated in the specification and the drawings must be regarded as only one illustrative example, and these are not intended to limit the present invention. Furthermore, it must be understood that various modifications, additions and substitutions are possible at the point of time of application of the present invention.

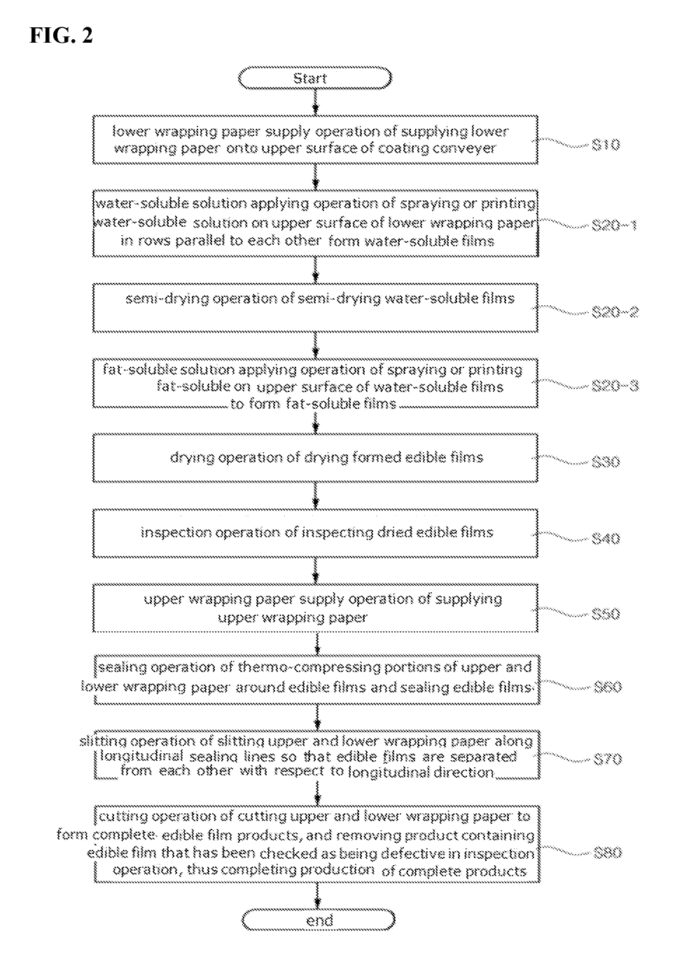

FIG. 2 is a flowchart of a method of manufacturing an edible film product according to the present invention.

The edible film product manufacturing method includes applying solution to form an edible film, drying the formed edible film, dividing and cutting it into a plurality of pieces, and packing the pieces individually. The manufacturing method will be explained in detail below.

First, lower wrapping paper for packing the edible film is supplied. In other words, the lower wrapping paper is supplied onto an upper surface of a coating conveyer in a lower wrapping paper supply operation S10.

Subsequently, a solution to be formed into the edible film is applied in a thin film shape to an upper surface of the lower wrapping paper (a solution-applying operation).

The solution applying operation preferably includes a plurality of operations including a first solution applying operation S20-1 and a second solution-applying operation S20-3. More preferably, either the first solution applying operation S20-1 or the second solution-applying operation S20-3 includes applying a water-soluble composition solution to the lower wrapping paper, and the other operation includes applying a fat-soluble composition solution thereto.

In this embodiment, the first solution applying operation S20-1 includes applying the water soluble composition solution to the lower wrapping paper. The second solution applying operation S20-3 includes applying the fat-soluble composition solution to the lower wrapping paper.

Furthermore, after the first solution applying operation and the second solution applying operation have been completed, a third solution applying operation of applying water soluble composition solution to form a base film may be conducted in a multi-applying manner. That is, depending on characteristics of chemicals, triple applying operations may be carried out.

Moreover, a semi-drying operation S20-2 may be conducted between the first solution applying operation S20-1 and the second solution applying operation S20-3. The semi-drying operation S20-2 includes semi-drying a water-soluble edible film which has been applied to the lower wrapping paper.

The solution-applying operation will be explained in detail below.

First, in the solution-applying operation which is the water-soluble composition solution-applying operation 520-1, a coating conveyer is operated and water-soluble composition solution for the edible film is sprayed or printed onto the upper surface of the lower wrapping paper, thus forming a plurality of water-soluble edible films which have a predetermined size and are separated from each other. That is, pluralities of films which are separated from each other with respect to the longitudinal directions are formed. The water-soluble composition solution for the edible film may typically contain vitamin B-complex, vitamin C, etc which are water-soluble vitamins, and it is not limited to these vitamins.

Subsequently, in the semi-drying operation S20-2, the water-soluble edible film that has been applied on the lower wrapping paper in the water-soluble composition solution applying operation S20-1, which is the first solution applying operation, is semi-dried.

Thereafter, in the fat-soluble composition solution applying operation S20-3, fat-soluble composition solution for the edible film is sprayed or printed onto a n upper surface of the water-soluble edible film formed on the upper surface of the lower wrapping paper in the water-soluble composition solution applying operation S20-1, thus forming a fat soluble edible film. The fat-soluble composition solution for the edible film may not only be vitamins A, D, E, F, K and U which are fat soluble vitamins but also be fat soluble chemicals, etc., and it is not limited to these vitamins or chemicals.

Here, each of the first and second solution applying operations can be conducted in such a way that the solution applying operation is repeatedly conducted by a multi-intermittent coating machine. In this way, edible films of a predetermined size can be applied through a single applying process such that they are arranged in rows parallel to each other at positions spaced apart from each other at regular intervals.

Particularly, in the first solution-applying operation, a nozzle sprays water-soluble composition solution vertically onto the upper surface of the lower wrapping paper which is being supplied. While spraying the water-soluble composition solution onto the lower wrapping paper, the nozzle is preferably tilted in the direction in which the lower wrapping paper is transferred.

As such, because the nozzle can be tilted in the direction of the transfer of the lower wrapping paper while the water-soluble composition solution is vertically sprayed onto the upper surface of the lower wrapping paper, the water-soluble composition is vertically sprayed onto the upper surface of the lower wrapping paper, the water-soluble composition solution of a predetermined viscosity can be prevented from stretching (forming a tail).

In the second solution applying operation, it is preferable that a needle shaped nozzle discharge one or two drops of fat-soluble composition solution and apply it to the target. As such, if the needle shaped nozzle is used to discharge fat-soluble composition solution, the amount of discharge can be more precisely adjusted. In the case of an edible film for children, a variety of shapes, for example, characters children like, can be easily applied to the edible film.

After the solution-applying operation has been completed, the following operations are successively carried out.

The edible films that have been formed on the upper surface of the lower wrapping paper during the solution applying operation are completely dried in a drying operation S30.

Subsequently, an upper wrapping paper is supplied onto the upper surface of the lower wrapping paper on which the edible films have been applied, in an upper wrapping paper supply operation S50.

In a sealing operation S60, a perimeter of the upper wrapping paper that has been supplied in the upper wrapping paper supply operation S50 is sealed on the lower wrapping paper by thermo-compression bonded to each other around each edible film.

Subsequently, in a slitting operation S70, the upper and lower wrapping paper that have been sealed to each other with the edible films interposed therebetween are divided into several portions with respect to the longitudinal direction. In other words, the edible films that have been packed by the upper and lower wrapping paper in the sealing operation S60 are separated from each other with respect to the longitudinal direction so that they can be individually packed.

Finally, in a cutting operation S80, the portions of the upper and lower wrapping paper which have been separated from each other in the slitting operation S70 are cut with respect to the lateral direction, thus forming individually packed complete products. A product containing an edible film that has been determined as being defective in the inspection operation S40 is removed.

As stated above, the solution-applying operation includes the plurality of operations including the first solution-applying operation and the second solution-applying operation.

Therefore, in the case of an edible medicine film product, particularly, when a tiny dosage of medicine must be loaded onto an edible medicine film, a loss of medicine can be reduced as much as possible.

Furthermore, in the present invention, a variety of kinds of films can be manufactured through a multi-solution applying operation, when different kinds of medicines, for example, which are respectively absorbed in the mouth mucous membrane, the stomach and the intestine, are required.

Particularly, in the present invention, the water-soluble composition solution and the fat-soluble composition solution can be separately applied to the lower wrapping paper.

Thus, in the case of medicine manufacture, it can be manufactured in such a way that water-soluble medicine is loaded onto a film before small amount of fat-soluble medicine, which cannot resist heat, is applied to the film. Therefore, chemical changes in the medicines attributable to heat can be minimized.

Furthermore, the semi-drying operation is conducted between the first solution-applying operation and the second solution applying operation to set desirable temperature and moisture levels and to appropriately mix raw materials. The semi-drying operation makes it possible to secure the stability of materials and make the overall process more convenient.

In addition, the semi-drying operation is required when using a variety of techniques which are needed to apply raw materials to form a film, for example, an encapsulation technique for loading a fragrance onto a base film, or a micro-coating or nano-spray coating technique.

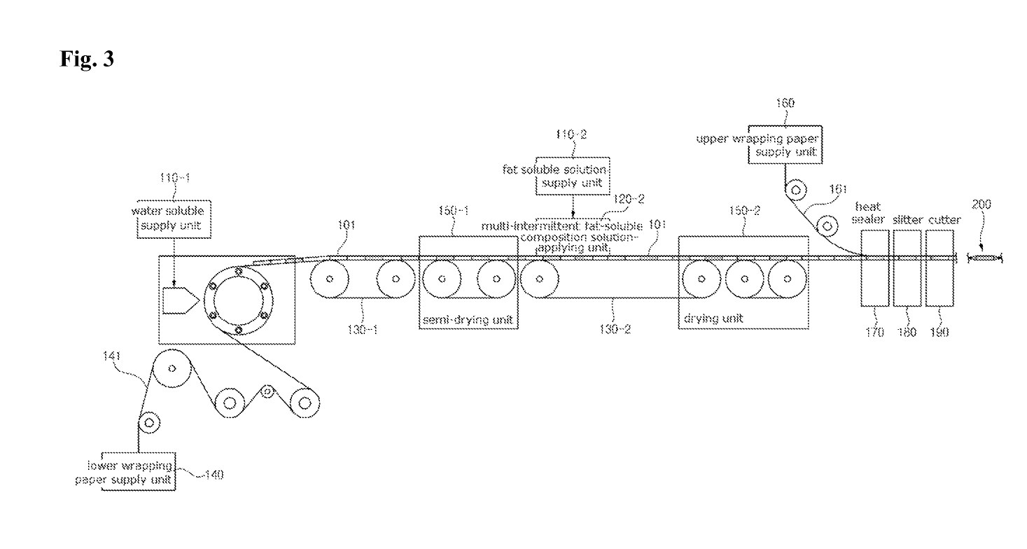

FIG. 3 is a schematic view illustrating an apparatus for manufacturing an edible film product, according to a first embodiment of the present invention.

As shown in FIG. 3, the edible film product manufacturing apparatus includes a water soluble solution supply unit 110-1, a first coating conveyer 130-1, a lower wrapping paper supply unit 140, a multi-intermittent water soluble composition solution applying unit 120-1, a semi-drying unit 150-1, a fat soluble solution supply unit 110-2, a second coating conveyer 130-2, a multi-intermittent fat soluble composition solution applying unit 120-2, a drying unit 150-2, an upper wrapping paper supply unit 160m a heat sealer 170, a slitter 180 and a cutter 190.

The water-soluble solution supply unit 110-1 functions to supply water-soluble solution for the edible film. In detail, the water-soluble solution supply unit 110-1 is a unit which supplies water-soluble composition solution to the multi-intermittent water soluble composition solution applying unit 120-1 at a constant supply rate.

The first coating conveyer 130-1 functions as a support plate which supports on the upper surface thereof the lower wrapping paper 141 and transfers it while water-soluble solution is applied onto the lower wrapping paper.

The lower wrapping paper supply unit 140 supplies the lower wrapping paper 141 for wrapping the edible film onto the upper surface of the first coating conveyer 130-1.

The multi-intermittent water-soluble composition solution applying unit 120-1 applies water-soluble solution supplied from the water-soluble solution supply unit 110 onto the upper surface of the lower wrapping paper 141 in such a way that edible films 101 are separately formed by the multi-intermittent applying method.

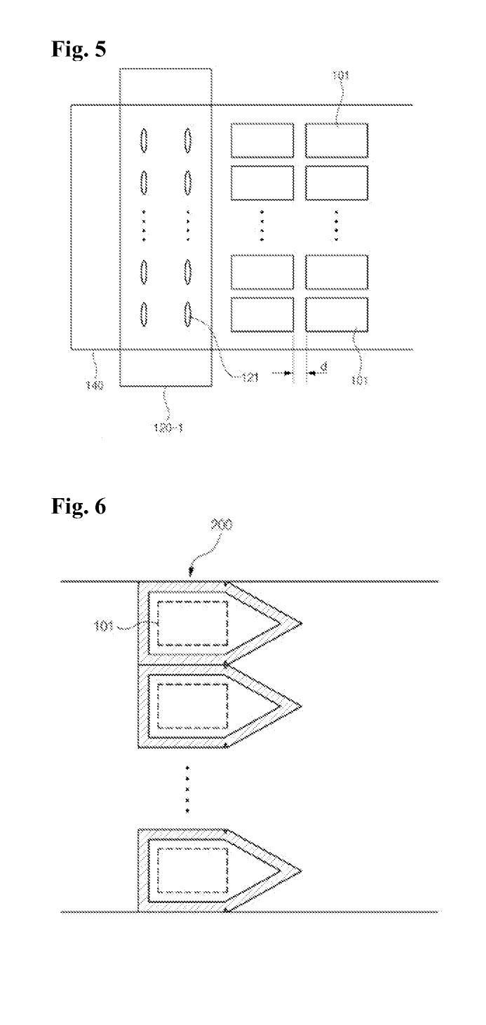

FIG. 5 illustrates an example of the multi-intermittent water soluble composition solution applying unit 120-1. Referring to FIG. 5, while water-soluble composition solution is supplied from the water soluble solution supply unit 110, the multi-intermittent water soluble composition solution applying unit 120-1 sprays water soluble composition solution using a pump (using positive pressure and including a piston, etc) through nozzle hole 121 formed in the lower surface of the multi-intermittent water soluble composition solution applying unit 120-1 and applies the solution onto the upper surface of the lower wrapping paper 141. Here, the nozzle holes 121 are arranged at positions spaced apart from each other at regular intervals so as to make it possible to apply solution onto multiple portions. In other words, several films can be formed in parallel multi-row arrangement at the same time.

This structure makes it possible to form a plurality of water soluble edible films 101 at the same time. The timing at which solution is discharged from the nozzle holes 121 can be controlled by controlling the pump (using positive pressure and including a piston, etc.) so that spraying solution and interruption of the spraying can alternate with each other at regular time intervals. That is, edible films 1010 which are separated from each other can be formed.

Depending on the arrangement structure of nozzle holes of the applying unit, several pieces of edible film 101 can be formed at one time in a parallel multi-row arrangement manner.

Alternately, another example of the multi0intermittent water-soluble-composition solution applying unit 120-1 may apply water soluble solution, supplied from the water soluble solution supply unit, onto the lower wrapping paper in such a way that edible films are printed on the lower wrapping paper by an embossed or engraved roller. Preferably, pluralities of patterns are formed on the roller at positions spaced apart from each other at regular intervals so that several pieces of edible films can be formed at one time.

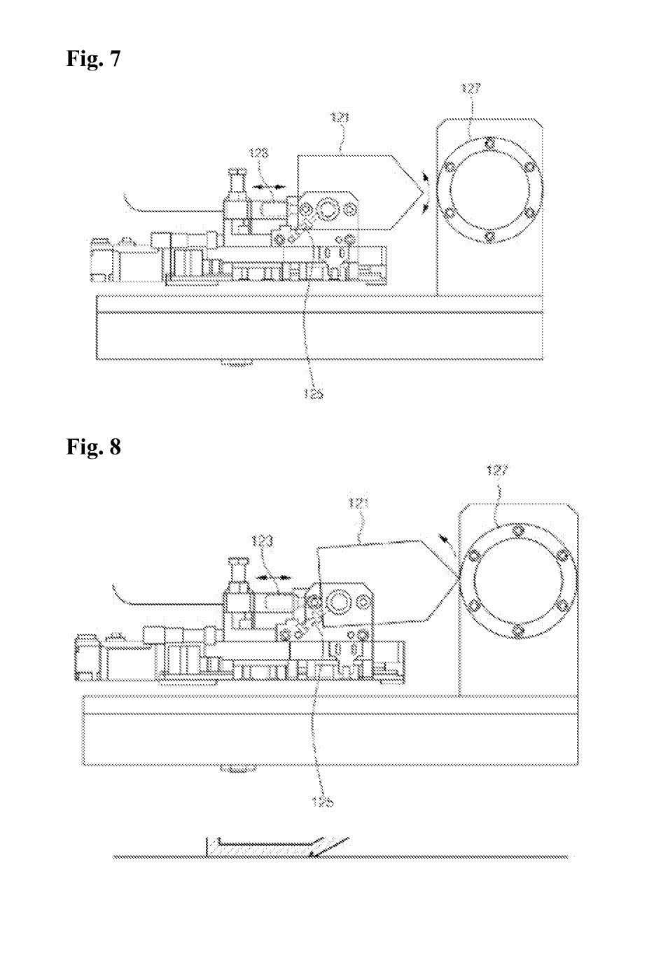

FIGS. 7 and 8 illustrate another example of the water-soluble composition solution applying unit 12-1. As shown in FIGS. 7 and 8, the water-soluble composition solution applying unit 120-1 preferably includes a nozzle 121 and a tilting unit 125.

The nozzle 121 sprays water-soluble solution perpendicular onto the lower wrapping paper, which is being supplied by a roller 127. The nozzle 121 is provided so as to be rotatable. The nozzle 121 is horizontally oriented while the lower wrapping paper is vertically supplied to the roller 127.

The tilting unit can tilt the nozzle 121 in a variety of manners, for example, using hydraulic pressure, a motor, a cylinder, etc.

Furthermore, a horizontal moving unit 123 is coupled to a portion of the nozzle 121 so that the nozzle 121 can be horizontally moved by the horizontal moving unit 123.

In the water soluble composition solution applying unit 120-1 having the above mentioned construction, the nozzle 121 sprays water soluble solution perpendicular onto the lower wrapping paper that is being supplied by the roller 127. At this time, as shown in FIG. 8, while water soluble solution is being sprayed, the nozzle 121 is tilted in the direction corresponding to the direction in which the roller 127 rotates. In FIG. 8, the nozzle 121 is rotated in the counterclockwise direction.

As such, the nozzle 121 is tilted in the direction of the rotation of the roller 127 while the nozzle 121 is spraying water-soluble composition solution perpendicular onto the lower wrapping paper that is being supplied by the roller 127. That is, the nozzle 121 moves along the lower wrapping paper that is being transferred by the roller 127. Here, if the nozzle 121 does not move, when water soluble composition solution is applied onto the lower wrapping paper, it may undesirably stretch rather than being accurately cut off. The present invention can prevent this phenomenon.

In other words, water-soluble composition solution which has comparatively high viscosity can be prevented from stretching (forming a tail). Therefore, water-soluble composition solution can be accurately sprayed and applied onto the lower wrapping paper.

The semi-drying unit 150-1 is disposed in the rear of the first coating conveyer 140-1 including a portion of the first coating conveyer 130-1. The semi-drying unit 150-1 semi-dries the water soluble edible film 101 that has been applied onto the lower wrapping paper by the multi-intermittent water soluble composition solution applying unit 120-1.

The second coating conveyer 130-2 is installed behind the semi-drying unit 150-1.

The second coating conveyer 130-2 serves as a transfer support plate for the water soluble edible film 101 that has been semi-dried and function to transfer the lower wrapping paper 141.

The fat soluble solution supply unit 110-2 functions to supply fat soluble solution for the edible film. In detail, the fat-soluble solution supply unit 110-2 is a unit which supplies fat-soluble composition solution to the multi-intermittent fat-soluble composition solution applying unit 120-2 at a constant supply rate.

The multi-intermittent fat soluble composition solution applying unit 120-2 applies fat soluble solution from the fat soluble solution supply unit 110-2 onto an upper surface of the water soluble edible film that has been applied on the upper surface of the lower wrapping paper 141.

Here, fat-soluble solution is applied onto the water-soluble edible film in a multi-intermittent applying manner to form the edible films 101.

An example of the multi-intermittent fat soluble composition solution applying unit 120-2 may be configured such that a needle shaped nozzle sprays solution, thus forming the edible films.

The drying unit 150-2 is disposed in the rear of the second coating conveyer 130-2 including a portion of the second coating conveyer 130-2. The drying unit 150-2 functions to completely dry the edible film 101.

In detail, the drying unit 150-2 is a unit which dries and hardens the edible films 101 formed on the upper surface of the lower wrapping paper 141. The drying unit 150-2 includes pluralities of dryers. The number of dryers is determined depending on characteristics of products.

The edible films 101 are dried while they successively pass through the pluralities of dryers.

The upper wrapping paper supply unit 160 supplies an upper wrapping paper 161 both onto the lower wrapping paper 141 that has passed through the drying unit 150-2 and onto the edible films 101 that have been applied on the upper surface of the lower wrapping paper 141.

The heat sealer 170 bonds portions of the upper and lower wrapping paper 161 and 141 around each edible film 101 to each other in a thermo-compression manner thus individually sealing each edible film 101.

FIG. 6 illustrates an example of the heat sealer 170. Referring to FIG. 6, the heat sealer 170 thermo-compresses portions of the upper and lower wrapping paper 161 and 141 around each edible film 101 in a predetermined shape, thus sealing each edible film 101.

The slitter 180 longitudinally separates products, which have been formed by individually sealing the edible films using the heat sealer 170, from each other. In other words, the slitter 180 slits a sheet having products, which have been sealed by the heat sealer 170 and arranged in rows parallel to each other, in the direction in which the sheet having products is being transferred.

The cutter 190 cuts several rows of the sheet having the products which are separated from each other by the slitter 180, thus forming individual packed products. In other words, the several rows of the sheet having the products are cut by the cutter 190 in the lateral direction, thus forming complete edible film products 200 which are individually packed. Alternatively, during the cutting operation, only perforated lines may be formed between the edible film products 200 rather than the edible film products 200 being completed separated from each other.

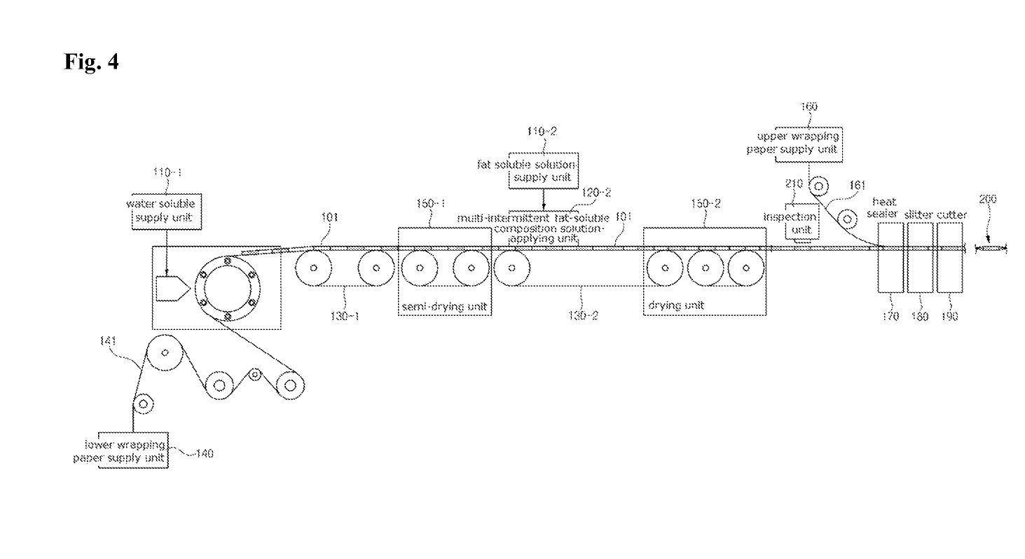

FIG. 4 is a schematic view of an apparatus for manufacturing an edible film product, according to a second embodiment of the present invention.

In the description of the edible film product manufacturing apparatus according to the second embodiment of the present invention, detailed explanation of the same construction as that of the edible film product manufacturing apparatus according to the first embodiment will be omitted.

The edible film product manufacturing apparatus according to the second embodiment further includes an inspection unit 210. Just before the upper surfaces of the edible films are packed by the upper wrapping paper, the inspection unit 210 inspects the edible films, which have passed through the drying unit 150-2 and been packed on the lower surfaces thereof by the lower wrapping paper, so as to check whether they are contaminated with impurities or are defective in coating or whether edible film omission has occurred. If a product which has a problem is detected in the inspection, the product is identified and then removed from the other products after the cutting operation.

The present invention having the above-mentioned construction is characterized in that the edible films 101 are directly formed on the upper surface of the lower wrapping paper 141 in such a way that water-soluble composition solution and fat-soluble composition solution are applied onto the lower wrapping paper 141 through separate processes.

In the present invention, the lower wrapping paper 141 is supplied onto the upper surface of the coating conveyer 130 and a plurality of pieces of edible film 101 are formed at the same time on the upper surface of the lower wrapping paper 141 by the multi-intermittent solution applying units 120. After the pieces of edible film are formed in rows parallel to each other at one time, they are dried. After the drying operation, the edible films are inspected to check whether they are defective. Thereafter, the upper wrapping paper 161 is supplied onto the edible films.

Subsequently, the edible films are heat sealed and then processed by the slitting and cutting operations, thus forming complete products which are individually packed.

As such, after the edible films are formed, they are packed in the same product line so that individual complete products are formed. Therefore, a separate operation of transporting the formed edible films to another place is not required, this preventing them from being contaminated. Furthermore, the present invention can produce complete products through only the single slitting and cutting process.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of manufacturing an edible film, comprising:
a plurality of applying operations of applying a solution for forming the edible film onto lower wrapping paper in a thin film shape, the solution-applying operations a first solution-applying operation and a second solution applying operation, wherein the solution applying operations comprise spraying the solution perpendicular to an upper surface of the lower wrapping paper from a nozzle, wherein while the solution is sprayed, the nozzle is tilted in a direction in which the lower wrapping paper is transferred.

2. The method according to claim 1, further comprising, between the first solution applying operation and the second solution applying operation, a semi-drying operation of semi-drying an edible film formed on the lower wrapping paper by the first solution applying operation.

3. The method according to claim 1, wherein either the first solution applying operation or the second solution applying operation comprises applying a water soluble composition solution and a remaining one of the first solution applying operation and the second solution applying operation comprises applying a fat soluble composition solution.

4. The method according to claim 1, further comprising, after the solution applying operations,
a drying operation of drying the edible film formed on the lower wrapping paper;
an upper wrapping paper supply operation of supplying upper wrapping paper onto the lower wrapping paper on which the edible film has been formed and dried;
a sealing operation of thermo-compressing a perimeter of the upper wrapping paper and a perimeter of the lower wrapping paper to each other and sealing the perimeters;
a slitting operation of dividing the sealed upper and lower wrapping paper into a plurality of portions with respect to a longitudinal direction; and
a cutting operation of cutting in a lateral direction the upper and lower wrapping paper of the edible film that has passed through the slitting operation.

5. The method according to claim 1, wherein the solution applying operations comprises applying the solution onto the upper surface of the lower wrapping paper in such a way that a plurality of edible films having a predetermined size are arranged in rows parallel to each other during a single applying process.

6. An apparatus for manufacturing an edible film, comprising;
a water soluble solution supply unit supplying a water soluble solution for forming the edible film;
a first coating conveyer comprising a support for application and transfer of the water soluble solution;
a lower wrapping paper supply unit supplying a lower wrapping paper for packing the edible film onto an upper surface of the first coating conveyer;
a multi-intermittent water soluble composition solution applying unit applying the water soluble solution supplied from the water soluble solution supply unit onto an upper surface of the lower wrapping paper in such a way that a plurality of pieces of edible films are separately formed by repeatedly conducting application of the water-soluble solution and interruption of the application;
a fat soluble solution supply unit supplying a fat-soluble solution for forming the edible film;
a second coating conveyer disposed behind the first coating conveyer, the second coating conveyer comprising a support for transfer of the water soluble edible film;
a multi-intermittent fat soluble composition-solution applying unit applying the fat soluble solution, supplied from the fat soluble solution supply unit onto an upper surface water soluble edible film formed on the upper surface of the lower wrapping paper; and a drying unit disposed in rear of the second coating conveyer to dry the edible film, wherein the multi-intermittent water soluble composition-solution applying unit comprises:
a nozzle spraying water-soluble solution perpendicular to the lower wrapping paper supplied by a roller; and a tilting unit tilting the nozzle, whereby while the water soluble solution is sprayed, the nozzle is tilted in a direction corresponding to a direction in which the roller rotates.

7. The apparatus according to claim 6, further comprising a semi-drying unit disposed in rear of the first coating conveyer to semi-dry the water-soluble edible film formed by the multi-intermittent water soluble composition applying unit.
